(19) United States
(12) Patent Application Publication
(10) Pub. No.: US 2016/0091786 A1
(43) Pub. Date: Mar. 31, 2016

(54) SCREEN CONFIGURATION FOR DISPLAY SYSTEM

(71) Applicant: Google Inc., Mountain View, CA (US)

(72) Inventors: Andrei S. Kazmierski, Pleasanton, CA (US); Adam E. Norton, Palo Alto, CA (US); Mary Lou Jepsen, Sausalito, CA (US)

(21) Appl. No.: 14/579,990

(22) Filed: Dec. 22, 2014

Related U.S. Application Data
(60) Provisional application No. 62/057,585, filed on Sep. 30, 2014.

(51) Int. Cl. G03B 21/62; H04N 9/31

(52) U.S. Cl. CPC G03B 21/625; H04N 9/3138; G02B 3/0068

(57) ABSTRACT

An optical configuration for a display system includes a front screen, a first microlens array, and a second microlens array. The front screen has optical properties to absorb ambient light and let image light through. The first microlens array is coupled to receive the image light from a pixel array of an image generation layer. The second microlens array is disposed between the front screen and the first microlens array. The second microlens array is offset from the first microlens array by approximately a focal length of microlenses in the first microlens array. The second microlens array is coupled to direct the image light received from the first microlens array through front screen. Each of the microlenses in the first microlens array is axially aligned with a corresponding microlens in the second microlens array.

### CROSS-REFERENCE TO RELATED APPLICATIONS

This application claims the benefit of U.S. Provisional Application No. 62/057,585 filed on Sep. 30, 2014, the contents of which are incorporated herein by reference.

### TECHNICAL FIELD

This disclosure relates generally to display systems, and in particular but not exclusively, relates to front screen configurations in display systems.

### BACKGROUND INFORMATION

Large displays can be prohibitively expensive as the cost to manufacture display panels rises exponentially with display area. This exponential rise in cost arises from the increased complexity of large monolithic displays, the decrease in yields associated with large displays (a greater number of components must be defect free for large displays), and increased shipping, delivery, and setup costs. Tiling smaller display panels to form larger multi-panel displays can help reduce many of the costs associated with large monolithic displays.

A large display system can be generated by projecting sub-images to form a unified image. However, these display systems come with a distinct set of challenges. Display systems that include projected images have screens for projecting the images. The optical properties of the front screen contribute to the contrast ratio and viewing angle of the display. In some contexts, it is desirable for the display to have a very high contrast ratio and uniform brightness even at a wide variety of viewing angles.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates a display apparatus that includes an image generation layer disposed between a screen layer and an illumination layer, in accordance with an embodiment of the disclosure.

FIG. 1B is a side view schematic of the configuration of a portion of the display apparatus illustrated in FIG. 1A, in accordance with an embodiment of the disclosure.

FIG. 2 illustrates a side view schematic of a screen layer configuration that includes a first and second microlens array, in accordance with an embodiment of the disclosure.

FIGS. 3A-3C illustrate example embodiments of a screen layer configuration, in accordance with an embodiment of the disclosure.

FIG. 4 shows an example configuration of a screen layer, in accordance with an embodiment of the disclosure.

### DETAILED DESCRIPTION

Embodiments of a display apparatus that includes a screen layer are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

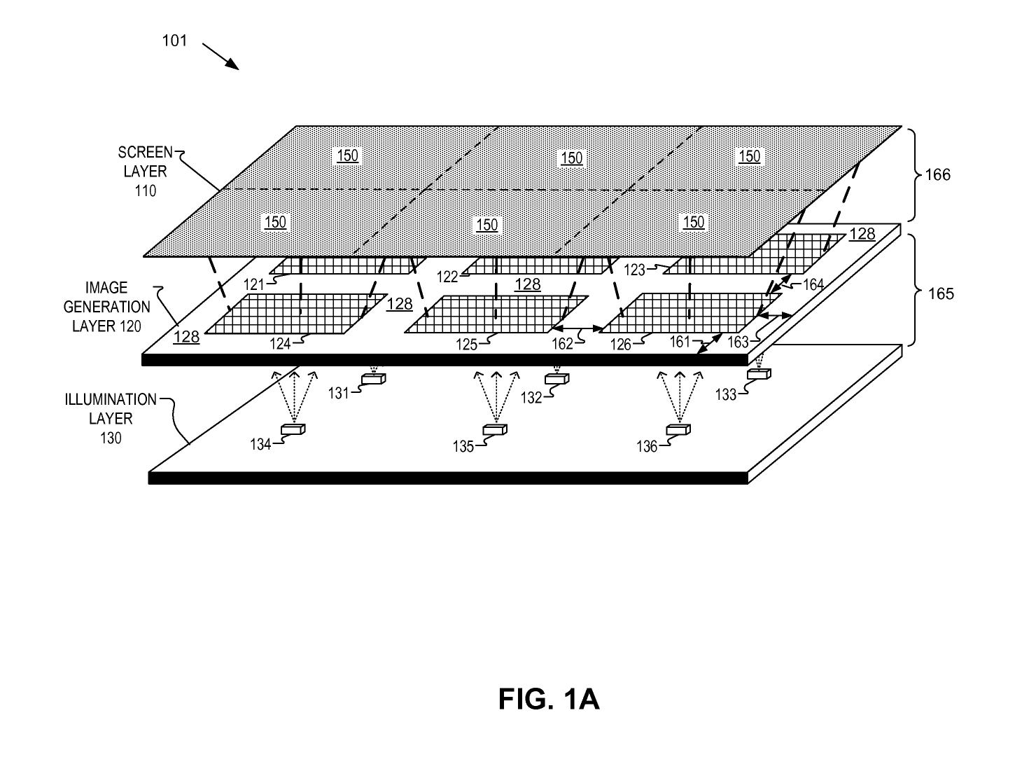

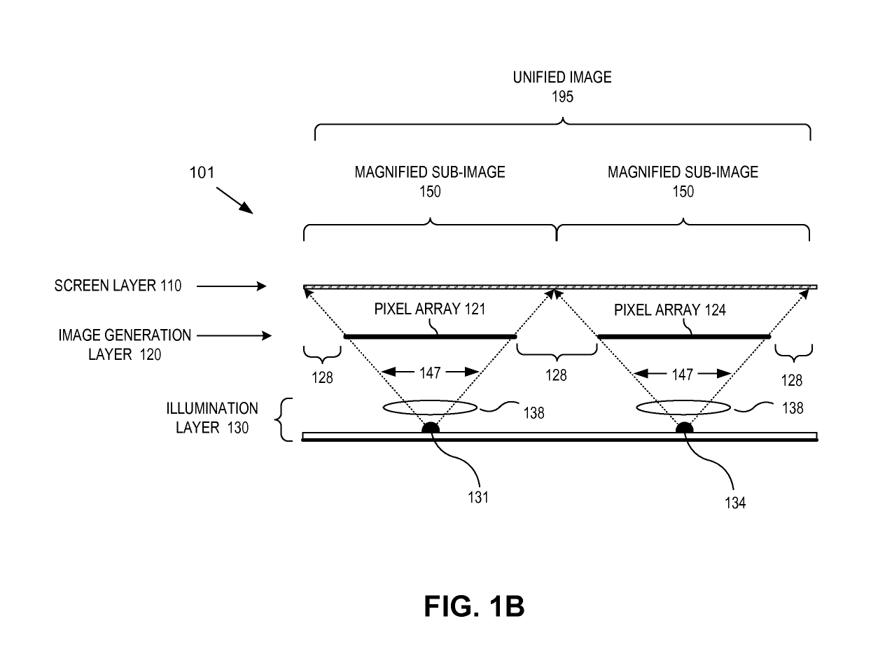

FIGS. 1A and 1B illustrate functional layers of a rear projection display apparatus 101, in accordance with an embodiment of the disclosure. FIG. 1A is a perspective view of the layers of display apparatus 101 while FIG. 1B is a side view schematic of the configuration of a portion of the display apparatus illustrated in FIG. 1A. FIG. 1B shows FIG. 1A illustrates display apparatus 101 that includes an image generation layer 120, disposed between a screen layer 110 and an illumination layer 130. FIG. 1A shows that illumination layer 130 includes an array of illumination sources 131, 132, 133, 134, 135, and 136. Each light source in the array of light sources illuminates a corresponding pixel array to project the sub-image generated by the pixel array onto the screen layer 110 as magnified sub-image 150. The magnified sub-images 150 combine to form unified image 195. In the embodiment illustrated in FIG. 1A, each pixel array is a transmissive pixel array arranged in rows and columns (e.g. 100 pixel by 100 pixels). In one embodiment, each pixel array is one inch by one inch.

The illustrated embodiment of image generation layer 120 includes transmissive pixel arrays 121, 122, 123, 124, 125, and 126 separated from each other by spacing regions 128. The illustrated embodiment of screen layer 110 is divided into six regions for displaying sub-images 150 of an overall unified image 195. Display 101 is made up of a plurality of pixlets, each including an illumination source (e.g. 134), transmissive pixel array (e.g. 124), and a screen region for displaying a sub-image 150 all aligned within a column through display 101. Multiple pixlets are separately projected such that together they form a tiled, seamless image at the screen layer 110.

In the illustrated embodiment, each illumination source is aligned under a corresponding pixel array to illuminate a backside of the corresponding pixel array with lamp light. For example illumination source 131 corresponds with pixel array 121 and illumination source 134 corresponds with pixel array 124. Illumination sources 131-136 may be implemented as independent light sources (e.g., color or monochromatic LEDs, quantum dots, etc.) that generate a divergent projection beam 147 having a well-defined angular extent or cone to fully illuminate their corresponding transmissive pixel array residing above on image generation layer 120. In one embodiment, the angular extent of projection beam 147 is twenty degrees. Projection beam 147 includes image light that includes sub-image 150 after proceeding through the transmissive pixel array as the image light is modulated by the sub-image driven onto the transmissive pixel array. Each light source appears approximately as a point source to its corresponding pixel array.

The illumination layer 130 and image generation layer 120 are separated from each other by a fixed distance 165 (e.g. 8 mm). This separation may be achieved using a transparent intermediary (e.g. glass or plastic layers) and may further include one or more lensing layers 138 (including lenses, apertures, beam confiners, etc.) to control or manipulate the angular extent and cross-sectional shape of the lamp light emitted from the illumination sources. In one embodiment, an illumination controller may be coupled to the illumination sources 131-136 to control their illumination intensity. Illumination layer 130 may include a substrate upon which the illumination sources 131-136 are disposed.

Transmissive pixel arrays 121-126 are disposed on the image generation layer 120 and each includes an array of transmissive pixels (e.g. 100 pixels by 100 pixels). Each pixel array is one inch square, in one embodiment. In one embodiment, the transmissive pixels may be implemented as backlit liquid crystal pixels. Each transmissive pixel array is an independent display array that is separated from adjacent transmissive pixel arrays by spacing regions 128 on image generation layer 120. The internal spacing distance 162 and 164 that separate adjacent pixel arrays from each other may be twice the width as the perimeter spacing distance 161 and 163 that separate a given pixel array from an outer edge of image generation layer 120. In one embodiment, the internal spacing distance 162 and 164 have a width of 4 mm while the perimeter spacing distance 161 and 163 have a width of 2 mm. Of course, other dimensions may be implemented.

As illustrated, transmissive pixel arrays 121-126 are spaced across image generation layer 120 in a matrix with spacing distance 162 and 164 separating each transmissive pixel array 121-126. In one embodiment, transmissive pixel arrays 121-126 each represent a separate and independent array of display pixels (e.g., backlit LCD pixels). Spacing distances 161-164 are significantly larger than the inter-pixel separation between pixels of a given transmissive pixel array 121-126. Spacing regions 128 improve signal routing option and/or make space available for the inclusion of additional circuitry, such as a display controller. Spacing region 128 that resides along the exterior perimeter also provides space for power and/or communication ports.

Although FIG. 1A illustrates image generation layer 120 as including six transmissive pixel arrays 121-126 arranged into two rows and three columns, it should be appreciated that various implementations of display 101 may include more or less transmissive pixel arrays organized into differing combinations of rows and columns. As such, in embodiments having a one-to-one ratio of illumination sources 131-136 to transmissive pixel arrays 121-126, the number and layout of illumination sources on illumination layer 130 may also vary. While FIG. 1A does not illustrate intervening layers between the three illustrated layers for the sake of clarity, it should be appreciated that embodiments may include various intervening optical or structural sub-layers, such as lens arrays, transparent substrates to provide mechanical rigidity and optical offsets, protective layers, or otherwise.

Transmissive pixel arrays 121-126 are switched under control of a display controller to modulate projection beam 147 and project sub-image 150 onto screen layer 110. Sub-images 150 collectively blend together to present a unified image 195 to a viewer from the viewing side of screen layer 110 that is substantially without seams. In other words, the sub-images created by transmissive pixel arrays 121-126 are magnified as they are projected across separation 166 (e.g., 2 mm) between image generation layer 120 and screen layer 110. The sub-images 150 are magnified enough to extend over and cover spacing region 128 forming a seamless unified image 195. The magnification factor is dependent upon separation 166 and the angular spread of divergent projection beam 147 emitted by illumination sources 131-136. In one embodiment, sub-image 150 is magnified by a factor of approximately 1.5. Not only does the unified image 195 cover the internal spacing distances 162 and 164, but also covers the perimeter spacing distances 161 and 163. As such, display 101 may be positioned adjacent to other display tiles 101 and communicatively interlinked to form larger composite seamless displays, in which case the unified image 195 generated by a single display tile becomes a sub-portion of a multi-tile unified image.

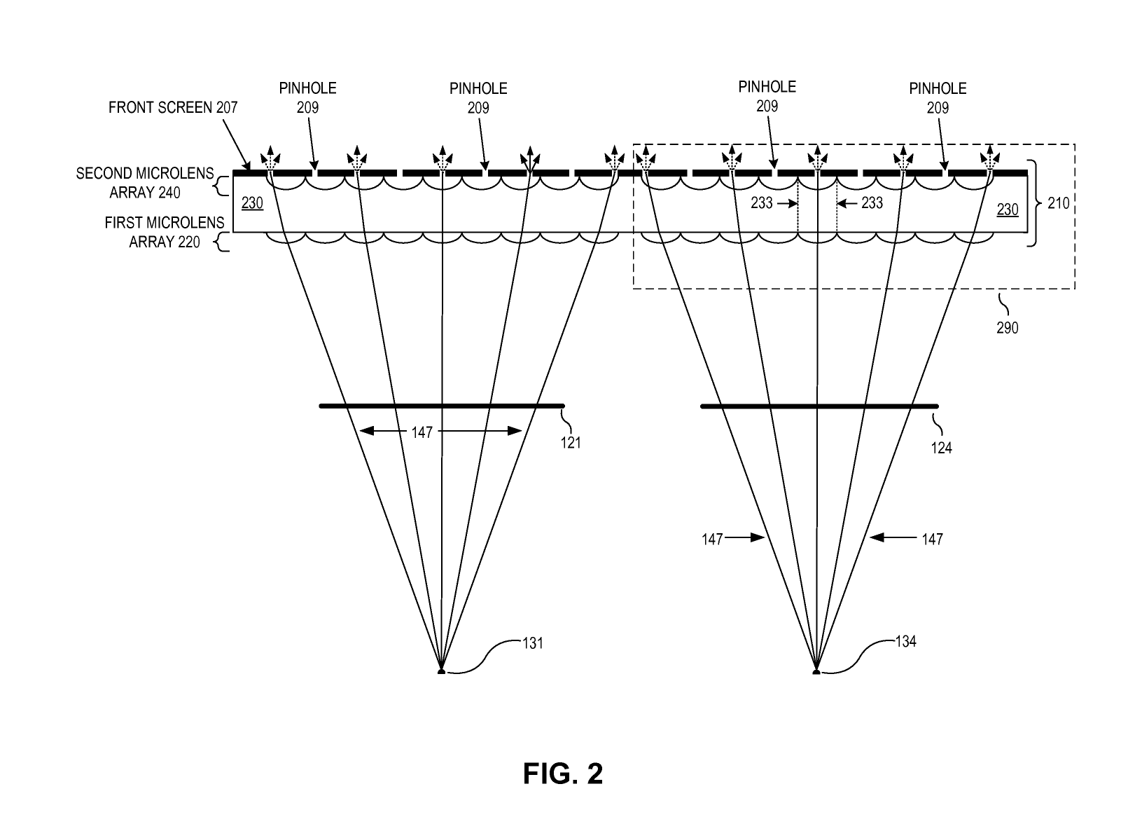

In a tiled rear-projection architecture, such as the one illustrated in FIGS. 1A and 1B, image light incident upon screen layer 110 is not collimated. This divergent light can result in angular brightness variations at different locations across screen layer 110. This deviation can be greatest around the perimeter of each sub-image 150. Prior approaches to address this deviation have included placing Fresnel lenses right behind the front screen to collimate the image light before it encounters the front screen. However, it is difficult to completely eliminate visible artifacts that appear at seams between the Fresnel lenses. Another prior approach has been to use microlenses to focus the image light into pinholes of a light absorbing screen layer. However, in that approach, the pinholes are filled with a scattering material (to primarily scatter the image light at an orientation that is normal to the front screen) that reflects a large portion of the image light back toward the microlenses. The reflection of the image light back to the microlenses is both inefficient and a possible source of optical crosstalk between the pinholes functioning as pixels of the light absorbing screen layer. Accordingly, FIGS. 2-4 present rear-projection screen architectures that provide improved optical efficiency and increased uniformity of angular distribution of image light across screen layer 110.

FIG. 2 illustrates a side view schematic of the screen layer configuration 210 that includes a front screen 207, a first microlens array 220, and a second microlens array 240, in accordance with an embodiment of the disclosure. Screen layer configuration 210 is one example of screen layer 110. There may be an encapsulation material as intermediate layer 230 disposed between the first microlens array 220 and the second microlens array 240, as illustrated. Front screen 207 has optical properties to absorb ambient light (being opaque), which will increase the contrast ratio of display 101. Front screen 207 includes an array of pinholes 209 through it. The array of pinholes may be through less than 10 percent of the front screen 207 such that front screen 207 stills absorbs an overwhelming majority of ambient light in an environment.

First microlens array 220 is optically coupled to receive image light from the pixel arrays 121-126 of image generation layer 120. Second microlens array 240 is disposed between front screen 207 and the first microlens array 220. Second microlens array 240 is offset from first microlens array 220 by approximately a focal length of microlenses in first microlens array 220, but not offset by less than the focal length of microlenses in first microlens array 220. In one embodiment, second microlens array 240 is offset from first microlens array 220 by an offset distance that is slightly larger than a focal length (e.g. between 1.0× and 1.2× the focal length) of microlenses in first microlens array 220. Optical experiments suggest improved angular optical correction is achieved when offsetting the second microlens array 240 from first microlens array 220 by an offset distance that is slightly larger than a focal length of microlenses in first microlens array 220. Second microlens array 240 is coupled to direct the image light received from the first microlens array 220 through the array of pinholes 209. Second microlens array 240 may direct a chief ray of the image light through pinhole 209 such that the chief ray of the image light exits the pinhole normal to the plane of front screen 207. Having second microlens array 240 directing a chief ray of the image light through pinholes 209 (rather than focusing image light onto a diffusive screen) may substantially increase the efficiency of displays that utilize the disclosed optical configuration, since angular correction of the light through each pinhole is achieved without having to use a diffusive material that may introduce significant absorption and/or back-scatter light.

Each microlens in first microlens array 220 has a corresponding microlens in second microlens array 240 that is axially aligned with its corresponding microlens in the first microlens array 220. The configuration of the first and second microlens array has a numerical aperture of illumination that is at or below an acceptance angle of the configuration. In other words, once the image light from image generation layer 120 enters a microlens in the first microlens array, that image light stay within an optical path boundary 233 that is limited to the microlens in the first microlens array and the corresponding axially aligned microlens in the second microlens array along with the space or encapsulation material (if any) between the corresponding microlenses. This configuration prevents optical crosstalk between adjacent non-corresponding microlenses and ensures the image light that is incident on a given microlens in the first microlens array will eventually exit a pinhole 209 that corresponds to the given microlens.

The lens configurations, number of microlenses, and microlens curvatures illustrated in FIG. 2 are to illustrate the concept, but other configurations and curvatures may be used in practice. Cutout 290 in FIG. 2 includes a portion of first microlens array 220, a portion of second microlens array 240, and a portion of front screen 207. These portions are designed specifically to create a magnified sub-image 150 from the image light received from pixel array 124. Display apparatus 101 includes six of these portions of front screen 207, microlens array 220, and microlens array 240 to create the six sub-images 150 from the image light from pixel arrays 121-126.

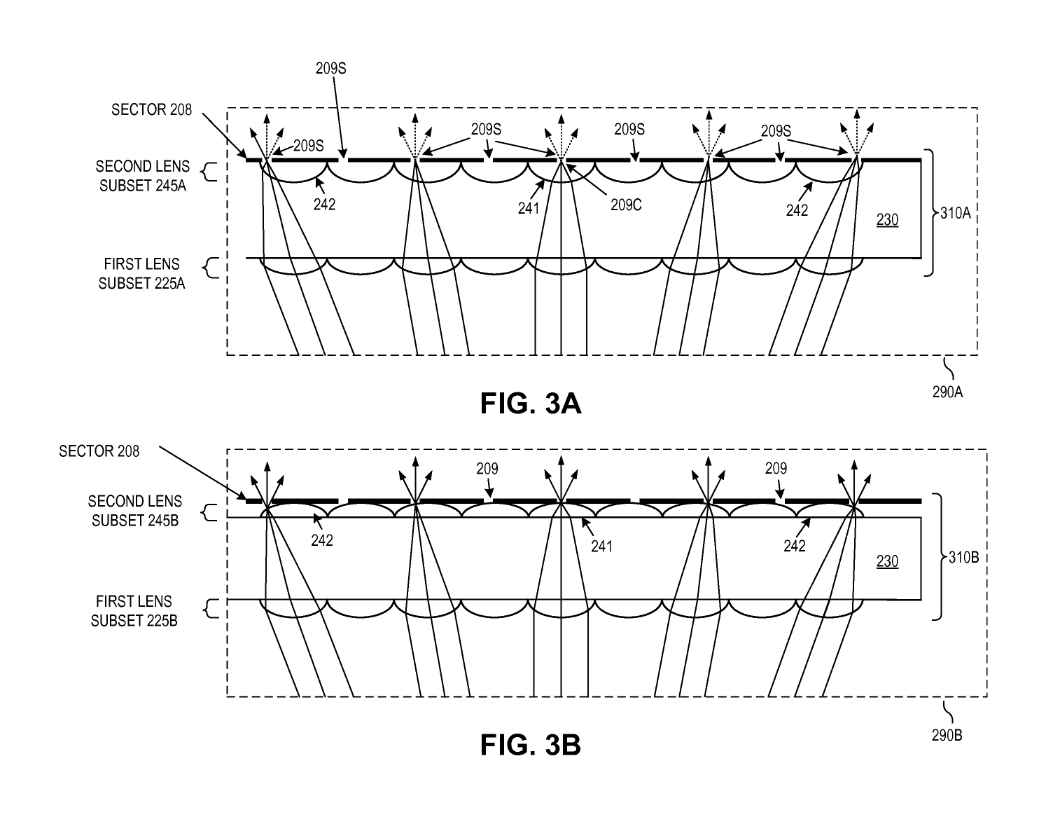

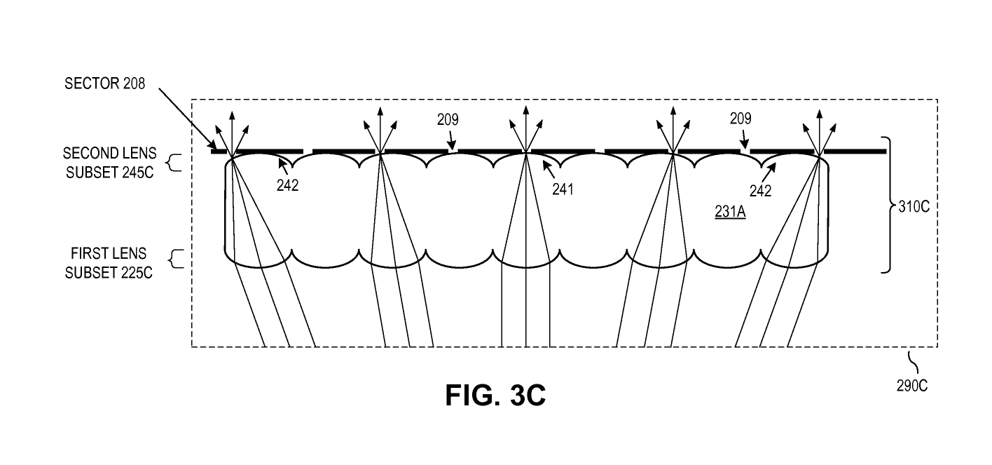

FIGS. 3A-3C illustrate example embodiments of a screen layer configuration that includes more specific examples of these portions of screen layer 210 in cutout 290, in accordance with an embodiment of the disclosure. FIG. 3A illustrates the portion of front screen 207 as front screen sector 208, the portion of the first microlens array 220 as first lens subset 225A, and the portion of second microlens array 240 as second lens subset 245A. Screen layer 310A includes front screen sector 208, first lens subset 225A, second lens subset 245A, and intermediate layer 230. Intermediate layer 230 may be an airgap or it may be an encapsulation material. The encapsulation material may have a different index of refraction than the first and second microlens array. It is also understood that an additional encapsulation material may be used that is not disposed between first lens subset 225A and second lens subset 245A. For example, if layer 230 has the same index of refraction as first lens subset 225A and second lens subset 245A, an additional encapsulation material having a lower index of refraction may be used to surround first lens subset 225A and second lens subset 245A.

In FIG. 3A, second lens subset 245 includes a center lens 241 centered around a center pinhole 209C. In one embodiment, second lens subset 245A has a homogeneous pitch (e.g. 60 um) between the microlenses while pinholes 209S that surround center pinhole 209C progressively increase their distance from each other the farther they get from center pinhole 209C. Therefore, the lenses of second lens subset 245A that surround center lens 241 are offset from centers of the their corresponding pinholes by an offset distance that increases progressively as a distance from center lens 241 increases. Although the pinholes 209 are not uniformly spaced, a viewer of display apparatus may not notice the non-uniform spacing of pinholes 209 (which function as pixels) if the spacing non-uniformity is below the resolution of the human eye. When second lens subset 245A has a homogeneous pitch, first lens subset 225A has the same homogeneous pitch to keep the lenses in the first lens subset 225A axially aligned with the lenses in the second lens subset 245A.

The perimeter lenses 242 are aligned so that their corresponding pinholes are furthest from their center because the perimeter lenses 242 receive the image light at the most oblique angle compared with the other microlenses in second lens subset 245A. In contrast, center pinhole 209C is axially aligned at the center of center lens 241 because center lens 241 receives the image light at the least oblique angle. The configuration of the microlenses and the increasingly offset pinholes is designed to have the image light exit through pinholes 209 normal to a plane of front screen 207 as effectively telecentric image light for improved viewing of unified image 195.

In FIG. 3A, a curvature of the microlenses in the first microlens array 220 face the same direction as a curvature of microlenses in second microlens array 240—both curvatures face toward image generation layer 120. FIGS. 3B and 3C differs from FIG. 3A in that the curvature of the microlenses in the first microlens array 220 face the opposite direction as the curvature of microlenses in second microlens array 240. In FIG. 3B, screen layer 310B includes front screen sector 208, first lens subset 225B, second lens subset 245B, and intermediate layer 230. In FIG. 3C, screen layer 310C includes front screen sector 208, first lens subset 225C, and second lens subset 245C. However, in FIG. 3C, first lens subset 225C and second lens subset 245C are integrated into a contiguous part 231 of the same material. Having a single contiguous part 231 may save on manufacturing costs. Contiguous part 231 may be formed from plastics such as acrylic, polycarbonate, or styrene that could be used when contiguous part 231 is made using an injection mold. Contiguous part 231 may also be fabricated with a ultraviolet (“UV”) curable resin. In one embodiment, contiguous part 231 is made from glass such as BK7.

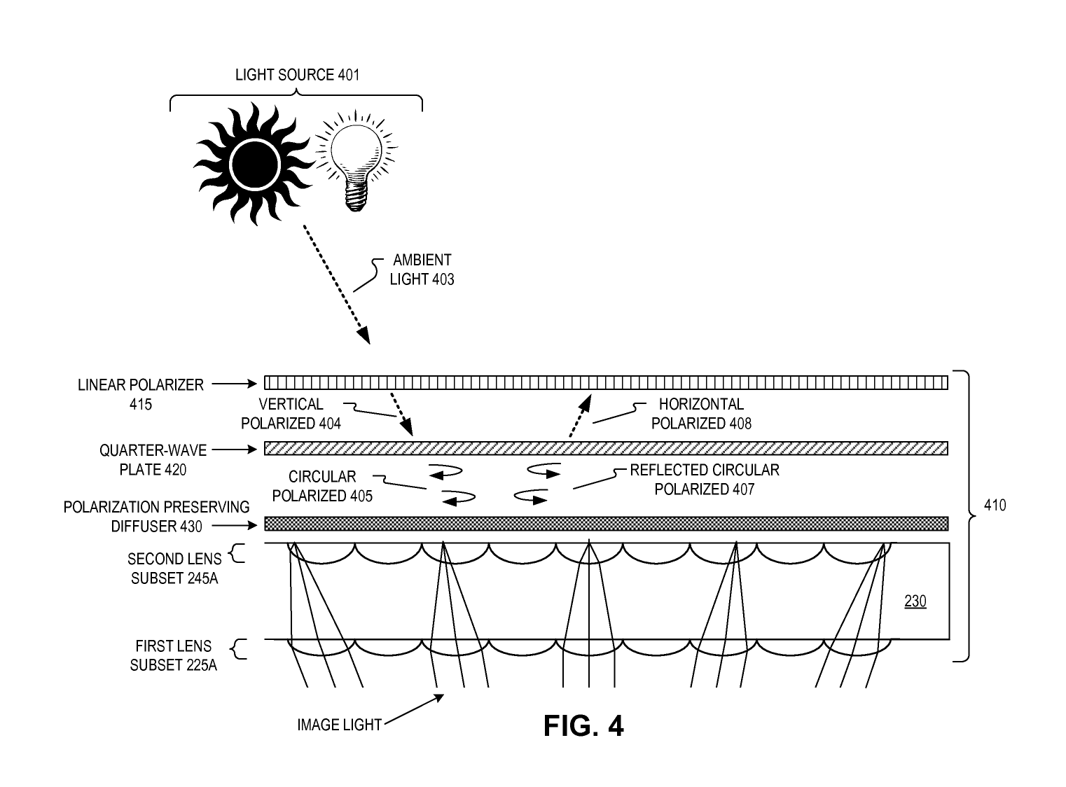

FIG. 4 shows an example configuration of a portion of screen layer 410, in accordance with an embodiment of the disclosure. Screen layer 410 can be used as screen layer 110, although only the portion of screen layer 410 that would be placed over one pixel array of image generation layer 120 is shown for illustration. Front screen layer 410 is an alternative to screen layers 310A, 310B, and 310C. Instead of relying on a front screen that has pinholes to emit image light (but generally absorbs ambient light), screen 410 includes a polarization scheme. Screen layer 410 includes first lens subset 225A, second lens subset 245A, quarter-wave plate 420, linear polarizer layer 415, and optionally, polarization preserving diffuser 430. Contiguous part 231 or first lens subset 225B and second lens subset 245B could replace first lens subset 225A and second lens subset 245A in FIG. 4. Polarization preserving diffuser 430, quarter-wave plate 420, and linear polarizer 415 are illustrated with space between them for the purposes of description, although in practice there may be no space between them. Of course, un-illustrated intervening layers could also be place between the illustrated layers.

To illustrate the function of screen layer 410, unpolarized ambient light 403 is incident upon linear polarizer layer 415. The horizontal portion of ambient light 403 is absorbed by linear polarizer 415, while the vertical portion of ambient light 403 passes through linear polarizer 415 as vertical polarized light 404. When vertical polarized light 404 encounters quarter-wave plate 420, it becomes circular polarized light 405. A portion of circular polarized light 405 may be absorbed by the display components below second lens subset 245A, while the remaining portion of circular polarized light 405 is reflected as reflected circular polarized light 407. Reflected circular polarized light 407 has an opposite rotation (e.g. clockwise vs. counter-clockwise) as circular polarized light 405. Reflected circular polarized light 407 then encounters quarter-wave plate 420, which converts reflected circular polarized light 407 into horizontal polarized light 408, which is absorbed by linear polarizer 415. Thus, the polarizing scheme of screen layer 410 absorbs ambient light 403, which boosts the contrast ratio of display 101. The image light traveling through the first and second microlens array (and through polarizing preserving diffuser 430, if used) has a polarization that is converted to vertically polarized image light when it encounters quarter-wave plate 420, which allows the image light to pass through linear polarizer 415. Therefore, the advantage of screen layer 410 is that the microlens configuration (and polarization preserving diffuser 430, if used) provides image light that has a chief ray directed normal to screen layer 410 for viewing and that the image light propagates through quarter-wave plate 420 and linear polarizer 415 at a high efficiency. At the same time, linear polarizer 415 and quarter-wave plate 420 help to absorb ambient light 403 so that front screen 410 appears black (rather than reflecting the ambient light) for boosting contrast ratio.

Polarization preserving diffuser 430 may be an engineered diffuser that includes an array of non-uniform microlenses that are designed to effect a particular scatter distribution of the image light. The curvatures of the non-uniform microlenses are designed to scatter the image light in the desired scatter distribution. An Engineered Diffuser™ from RPC Photonics of Rochester, N.Y. is one possible diffuser that can be used as polarization preserving diffuser 430. SUSS MicroOptics of Switzerland, NIL Technology of Denmark, and MEMS Optical of Huntsville, Ala. may also manufacture suitable engineered diffusers.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An optical configuration for a display system comprising:
a front screen having optical properties to absorb ambient light, wherein the front screen includes an array of pinholes;
a first microlens array coupled to receive image light from a pixel array of an image generation layer; and
a second microlens array disposed between the front screen and the first microlens array, wherein the second microlens array is offset from the first microlens array by approximately a focal length of microlenses in the first microlens array, and wherein the second microlens array is coupled to direct the image light received from the first microlens array through the array of pinholes, each of the microlenses in the first microlens array axially aligned with a corresponding microlens in the second microlens array.

2. The optical configuration of claim 1 further comprising an encapsulation material disposed between the first microlens array and the second microlens array.

3. The optical configuration of claim 2, wherein the encapsulation material has a different index of refraction than the first and second microlens array.

4. The optical configuration of claim 1, wherein the second microlens array includes a plurality of lens subsets, each lens subset including:
a center lens centered around a center pinhole in the array of pinholes; and
surrounding lenses offset from centers of corresponding pinholes by an offset distance, wherein the offset distance increases progressively as a distance from the center lens increases.

5. The optical configuration of claim 4, wherein the first microlens array has a homogeneous pitch between microlenses in the first microlens array, and wherein the second microlens array has the homogeneous pitch between microlenses in the second microlens array, and further wherein a spacing between pinholes in the array of pinholes increases as the offset distance increases.

6. The optical configuration of claim 1, wherein a configuration of the first and second microlens array has a numerical aperture of illumination that is at or below an acceptance angle of the configuration to prevent optical crosstalk between adjacent microlenses in the second microlens array.

7. The optical configuration of claim 1, wherein the second microlens array directs a chief ray of the image light normal to a plane of the front screen.

8. The optical configuration of claim 1, wherein the first microlens array and the second microlens array are integrated into a contiguous part of a same material.

9. The optical configuration of claim 1, wherein a first curvature of the microlenses in the first microlens array faces a same direction as a second curvature of microlenses in the second microlens array.

10. The optical configuration of claim 1, wherein a first curvature of the microlenses in the first microlens array faces an opposite direction of a second curvature of the microlenses in the second microlens array.

11. The optical configuration of claim 1 further comprising:
an illumination layer having a plurality of light sources, wherein each of the light source is configured to emit a divergent projection beam having a well-defined angular extent; and
an image generation layer having a plurality of pixel arrays spaced apart from neighboring pixel arrays in the plurality of pixel arrays, wherein each pixel array is configured to receive the divergent projection beam from one of the light sources in the plurality of light sources and generate the image light that includes a projected sub-image.

12. The optical configuration of claim 11, wherein each of the light sources in the plurality of light sources is centered under one pixel array in the plurality of pixel arrays.

13. The optical configuration of claim 12, wherein the second microlens array includes a plurality of lens subsets, each lens subset including:
a center lens centered around a center pinhole in the array of pinholes, wherein the center lens is axially aligned with a center of one of the light sources.

14. The optical configuration of claim 1, wherein the second microlens array is offset from the first microlens array by between 1.0× and 1.2× a focal length of the microlenses in the first microlens array.

15. A display apparatus comprising:
an illumination layer having a plurality of light sources, wherein each of the light sources is configured to emit a divergent projection beam having a well-defined angular extent;
an image generation layer having a plurality of pixel arrays spaced apart from neighboring pixel arrays in the plurality of pixel arrays, wherein each pixel array is configured to receive the divergent projection beam from one of the light sources in the plurality of light sources and generate image light including a projected sub-image;
a first microlens array coupled to receive the projected sub-images from the image generation layer;
a linear polarizer layer, wherein the projected sub-images combine to form a unified image;
a quarter-wave plate disposed between the first microlens array and the linear polarizer layer; and
a second microlens array disposed between the quarter-wave plate and the first microlens array, wherein the second microlens array is coupled to direct the image light received from the first microlens array to encounter the quarter-wave plate at an angle nominally normal to a plane of the quarter-wave plate, each of the microlenses in the first microlens array axially aligned with a corresponding microlens in the second microlens array.

16. The display apparatus of claim 15 further comprising a polarization preserving diffuser configured to shape an angular distribution of the image light after the image light exits the second microlens array, wherein the polarization preserving diffuser includes a non-homogeneous microlens array.

17. The display apparatus of claim 16, wherein the polarization preserving diffuser is disposed between the second microlens array and the quarter-wave plate.

18. The display apparatus of claim 15 further comprising an encapsulation material disposed between the first microlens array and the second microlens array.

19. The display apparatus of claim 18, wherein the encapsulation material has a different index of refraction than the first and second microlens array.

20. The display apparatus of claim 15, wherein a configuration of the first and second microlens array has a numerical aperture of illumination that is at or below an acceptance angle of the configuration to prevent optical crosstalk between adjacent microlenses in the second microlens array.
